(19) United States
(12) Patent Application Publication
(10) Pub. No.: US 2005/0048454 A1
(43) Pub. Date: Mar. 3, 2005

(54) Diet planner and method

(76) Inventor: Patricia Rivera Arana, Pedregal De San Angel (MX)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/652,706

(22) Filed: Aug. 29, 2003

(51) Int. Cl. G09B 23/28

(52) U.S. Cl. 434/262

(57) ABSTRACT

A diet planner and method providing a card showing a plurality of food item lists and the portion permitted, wherein the food item lists are divided into categories and each category name presents a characteristic color. The combination of three or more categories creates a food group called “asterisk” which maintains stable the sugar levels (glucose) in the blood.

### BACKGROUND OF THE INVENTION

1. Field of the Invention

The present invention relates generally to a diet planner and method, and more particularly it relates to a new, improved and easy-to-use diet planner and method which provides a balanced diet for health maintenance, disease prevention, loosing weight and maintaining health.

2. Description of the Related Art

In order for a person to remain healthy and thin, it is necessary to count calories, but it is more important that the sugar levels in the blood remain stable. The brain needs glucose to function properly. For the brain to be able to obtain the fuel it needs, it is very important that the sugar arrives slowly into the blood.

Several patents disclose various means for planning menus and regulating the calories dietary intake.

For example, U.S. Pat. No. 5,044,958 discloses a planning board, a deck of meal menu cards and at least one daily total strip. Foods listed on the meal menu cards, which are sources of vitamins, or minerals are identified with a color and the board includes indicia setting forth requirements for sources of such vitamins and minerals for the number of days represented by columns on the board.

U.S. Pat. No. 5,640,774 discloses an apparatus to indicate a net calorie intake goal; such apparatus permits the record keeping of calories consumed and expended.

Thirty years ago, diets high in fats and animal protein became famous and Dr. Atkins's diet headed the list. This diet allowed the unlimited consumption of foods high in saturated fats such as sausages, eggs, meats and seafood.

This kind of diet limited the consumption of carbohydrates to 20 grams per day at its initial stage, and increased it to 60 grams during the maintenance stage.

With such a drastic reduction in the consumption of carbohydrates, the body is stressed and enters a process called ketosis, during which certain toxic substances, called ketone bodies, are produced.

This kind of diets represent a danger to health, since the excess of saturated fats on the long run increases cholesterol levels in the blood, thus increasing the risk of cardiovascular conditions.

Furthermore, the excess of proteins favors the loss of calcium in the bones, increases the levels of uric acid, and overloads the kidneys function.

The loss of weight produced through this diet is related to the dehydration of tissue, since not enough carbohydrates are consumed to provide glucose to the brain, the liver glycogen reserves are used, and for each released glycogen molecule three parts of water are lost.

With this type of diet, people lose weight quickly, but also fat, water, and muscular mass.

Inanition diets, or any kind of fast diet, make the body to interpret the lack of food as a period of scarcity or deficiency. The organs reduce their activity to preserve the energy required to live, and muscle is used up. When this kind of diets is followed, weight is lost, but the muscle is destroyed, and thus it is very easy to gain weight again.

Each kilogram of muscle uses up 46 calories per day, whereas one kilogram of fat only uses two, and therefore if muscle is destroyed, fewer calories are burned per day and at the end people store fat.

It has also been verified that when the body is put under the stress of a very low-calorie diet, hypothyroidism can be caused, this is, a reduced functioning of the thyroid gland.

When a person does not eat enough food, his/her metabolism diminishes, and he/she feels tired and sleepy. When people go back to their daily habits and increase the amount of food, they quickly recover the weight lost and we even exceed it, since the consumption of energy is lower.

Around 1930, the theory of calories originated, and thus diets were designed based on the following equation: energy that comes in=energy that goes out.

Thus, if we eat more calories than those we use up, we end up gaining weight, and if we use up more calories than the amount we eat, we may loss weight.

Based on this theory, in 1992 the recommendation of the First Nutritional Pyramid, designed by the Ministry of Agriculture of the United States of America, came into life. Based on the estimation of calories, the Nutritional Pyramid recommended the consumption of 6 to 11 servings of cereals per day, and to diminish the consumption of fats.

This recommendation was based on the following estimate: if carbohydrates provide 4 kilocalories per gram, and fats provide 9 kilocalories per gram, we are going to lose weight and improve our health to the extent in which we increase the consumption of cereals rich in carbohydrates and decrease the consumption of oils or fats.

This recommendation gave rise to several light products in the market, high in carbohydrates and low in fats. After years of following this kind of diet, the results of the statistical studies were completely different to those expected: the overweight problem almost doubled in 12 years. In 1988, 35% of women had overweight; in the year 2000, the percentage exceeded 52.5%.

According to the data reported by Harris Poll of the CNN, in the month of May of 2002, obesity had reached the proportions of an epidemic: 75% of Americans over 25 years have overweight, and the obesity percentage in children has doubled.

Another disease that rose to alarming levels was type II diabetes that generally appears in adulthood, and is currently present in children.

When people abuse of the consumption of carbohydrates due to a diet based on cereals and sodas, the level of sugar in the blood is unexpectedly increased, which favors the production of insulin, a hormone produced by the pancreas that allows the passing of sugars to the cells.

The cells that do not require such high amounts of sugar become resistant to the action of insulin and, with time, the pancreas is tired of a stressed functioning, until it ceases to produce insulin. The result is diabetes.

Another ailment related to the excess of carbohydrates is the increase of triglycerids in the blood, related to a greater rate of heart attacks.

After evaluating the results of diets high in carbohydrates, the applicant was confused.

If carbohydrates provide 4 kilocalories and fats provide 9 kilocalories, why do people gain weight every day, notwithstanding the fact that they eat less fat? The answer is that, in order to lose weight, it is not only necessary to count calories but, above all, to maintain the levels of sugar stable, as well as a hormonal balance in our bodies.

Not only is it important how much do you eat, but what do you eat: 100 calories that come from a baked potato are not the same 100 calories that come from the consumption of a cantaloupe. That is, the production of insulin depends upon the type of foods we eat.

Insulin is a hormone produced by the pancreas, and its function is to allow the passing of sugars found in muscular cells, and to store the remaining sugar as fat.

When we eat foods that contain carbohydrates, we favor the production of insulin. If we take them in excess, in the end they become fat.

Carbohydrates are found in a great variety of foods, such as cereals, fruits, milk, yogurt, leguminous and some vegetables.

Most people who wish to lose weight start the day eating a high percentage of carbohydrates, and their breakfast is based on fruit, milk, and cereals, and they are surprised because, even though they do not eat fats, they do not lose weight.

When we eat cereals, we consume carbohydrates, which are glucose chains that start being digested by the saliva and are absorbed by the intestine.

Once they reach the blood, they unload their contents of sugar, thus increasing the levels of glucose in the blood.

The brain needs sugar or glucose to function adequately. Since the body's priority is the brain's health, it is the only one, which can take the sugar directly from the blood.

When the brain has taken the amount of sugar it needs, if it detects that there is still sugar in the blood, it sends a signal to the pancreas and this organ secretes insulin, a hormone that reaches the blood and allows the passing of sugar to the liver and to the muscular cells. Once the warehouse in the liver and muscles is full, the remaining sugar is deposited as fat in the adipose tissue.

In this manner, a diet high in carbohydrates increases the production of insulin and ends converting the excess of sugars in fat. But this is not the worse fact, since once sugar is stored, the levels of sugar in the blood decrease below the normal levels and cause a state of hypoglycemia.

Two or three hours later, the brain needs sugar again, and is not able to find it, and thus mental responsiveness decreases, concentration is lost and sleepiness, tiredness, and bad moods occur, as well as the desire to devour anything that is put in front of us.

Thus, the high consumption of carbohydrates leads us to a vicious cycle, where eating prompts us to continue eating. On one hand, we increase the levels of sugar in the blood above the expected levels (hyperglycemia), and thus we increase the production of insulin. Afterwards, insulin allows the passing of sugars to the cells and ends up storing is as fat, in such a manner that the levels of sugar decrease, which causes a state of hypoglycemia that creates the need of sweet foods.

The secret to have an ideal weight, improve health, and increase the levels of energy depends on controlling the production of insulin and keeping stable the levels of blood sugar.

When sugar decreases below the normal levels, we feel weak and irritable; we lose concentration and are less productive. On the other hand, when the levels of glucose in the blood increase above the normal levels, insulin is produced and fat is stored in the adipose tissues, which gives rise to overweight or obesity.

One of the last discoveries in the field of nutrition is that the production of insulin not only depends on the amount of sugars that enter the blood, but also on the speed in which those carbohydrates are digested and assimilated.

Such speeds are measured through the glycemic index of foods.

The glycemic index is measured in foods that contain carbohydrates or sugars that, when digested and assimilated in the intestine, increase the levels of glucose in the blood.

The foods that contain sugars that enter the blood at a high speed are known as foods with a high glycemic index. Those that slowly enter the blood are known as foods with a low glycemic index.

The higher the glycemic index of a food, the more insulin the body produces. For this reason, not all foods that contain carbohydrates produce the same amount of insulin in the body.

Some foods are better than others, depending on the type of nutrients they contain.

Raw fruits and vegetables contain great amounts of fiber, which decreases the speed and absorption of sugars by the intestine. On the other hand, the sugar in white bread and potatoes is absorbed at a great speed, and favor the production of insulin, the great fat storehouse-keeper.

To measure the glycemic index of foods, a solution of glucose was administered to a group of volunteers. Since glucose is the sugar in the blood, a value of 100% was given to its speed of absorption.

Later, the speeds of different foods were registered and compared to the speed of glucose. The sugars in most fruits enters the blood at a slow pace, approximately at 40% or 50% of the speed of glucose, whereas the sugars of cereals reached a speed from 80% to 90%.

A baked potato reached a glycemic index (GI) of 121, exceeding the speed of glucose, while an apple registered a GI of 46.

To prevent the overproduction of insulin and thus to store sugar in the form of fat, it is important to decrease the speed at which sugars enter the blood.

A factor that delays the speed of absorption is the type of nutrients contained in foods.

Proteins and fats delay the absorption of carbohydrates. Cereals do not require any digestion in the stomach: they pass to the intestine and are immediately absorbed.

Conversely, proteins need the hydrochloric acid of the stomach to be digested and retain the foods that accompany them.

Fats also delay the speed of emptying of the stomach. The first thing that passes through the stomach is carbohydrates, afterwards proteins, and fats at the end. Since the stomach is in constant movement, if we eat fats, foods are combined and their speed of absorption is delayed.

The fiber of some foods delays the assimilation of sugars in the intestine. Therefore, it is recommended to consume a great amount of raw vegetables.

Proteins and fats also decrease the speed at which sugars enter the blood, and therefore it is recommended to eat a small portion of proteins and fats whenever we eat a carbohydrate.

Thus, the glycemic index helped me to discover that losing weight not only depends on counting calories, but on a whole hormonal system.

When sugars enter the blood in a step-wise fashion, the levels of glucose remain stable during the following five hours, which helps us to feel satisfied and gives us more physical and mental energy.

Additionally, not all fats are bad, and some of them produce benefits in our health. Fats transport liposoluble vitamins such as vitamins A, D, E and K; they make up hormones and maintain the temperature of the body. Also, they protect the internal organs such as the heart and lungs, and isolate the body against hits and the severity of weather.

When we reduce the ingestion of fats below the normal levels, there are deficiencies in the production of hormones. It is recommended to prevent the consumption of animal fats, such as butter, sausage, bacon, lard, cream, etc. These fats increase the production of Low-Density Lipoproteins known as LDL, or bad cholesterol, a type of fat that adheres to arteries and forms a plate that sometimes prevents the circulation of blood and causes heart attacks.

Therefore, a need exists for a simple and effective diet planner and method for ensuring that the user consumes the proper food items in order to ensure a balanced diet, and which overcomes the problems of the prior art above-noted.

### SUMMARY OF THE INVENTION

It is a purpose of the present invention to provide a simple and effective diet planner and method for ensuring a healthy diet, which overcomes the disadvantages of the prior art mentioned above. This purpose is primarily achieved by providing a diet planner and method wherein specific food information is provided in a card.

Such food information is grouped by colors; by combining one of each color, a visual set named “asterisk” is formed, which adds up to 300 calories and maintains the glucose levels in the blood stable, thus allowing the body to be healthier.

It is one object of the present invention to provide a diet planner and method that instruct people how to eat in a healthy and natural way, controlling the speed in which the glucose reaches the blood stream.

It is another object of the present invention to provide a diet planner and method that maintain the quality of life of the user and eradicate weight problems.

Still another object of this invention is to provide a diet planner and method that teaches persons to eat healthy by differentiating the characteristics of each color food group.

It is another object of the present invention to provide a diet planner and method that offers flexibility and versatility in the design of different balanced menus.

It is still another object of the present invention to provide a diet planner and method that controls the number of used up calories and the speed of sugar that reaches the blood.

Still another object of the present invention is to provide a diet planner and method that considers the glycemic index of foods and controls the number of calories.

Another object of this invention is to provide a diet planner and method that may be used for losing weight, to maintain a certain weight or for gaining weight.

Still another object of the present invention is to provide a diet planner and method that incorporates an adequate amount of fiber, which aids in the function of the intestines.

Another object of this invention is to provide a diet planner and method that incorporates an adequate amount of protein to prevent the loss of muscle mass and to aid in the production of enzymes and antibodies.

Still another object of the present invention is to provide a diet planner and method that incorporates an adequate amount of healthy fats, which reduce cholesterol levels in the blood, and allow the production of hormones.

Another object of this invention is to provide a diet planner and method that includes a variety in the selection of foods that will allow the body to obtain the amount of vitamins and minerals it needs in order to function properly.

Still another object of the present invention is to provide a diet planner and method that allows the user to bum fat easily without losing muscle, to increase concentration and memory, and to increase physical performance.

Another object of this invention is to provide a diet planner and method that can be adapted to the different tastes, preferences and lifestyle of each user.

### BRIEF DESCRIPTION OF THE DRAWINGS

In the drawings:

The FIGURE shows a card with a plurality of food items to be used in a diet planner according to the invention.

### DESCRIPTION OF THE PREFERRED EMBODIMENT

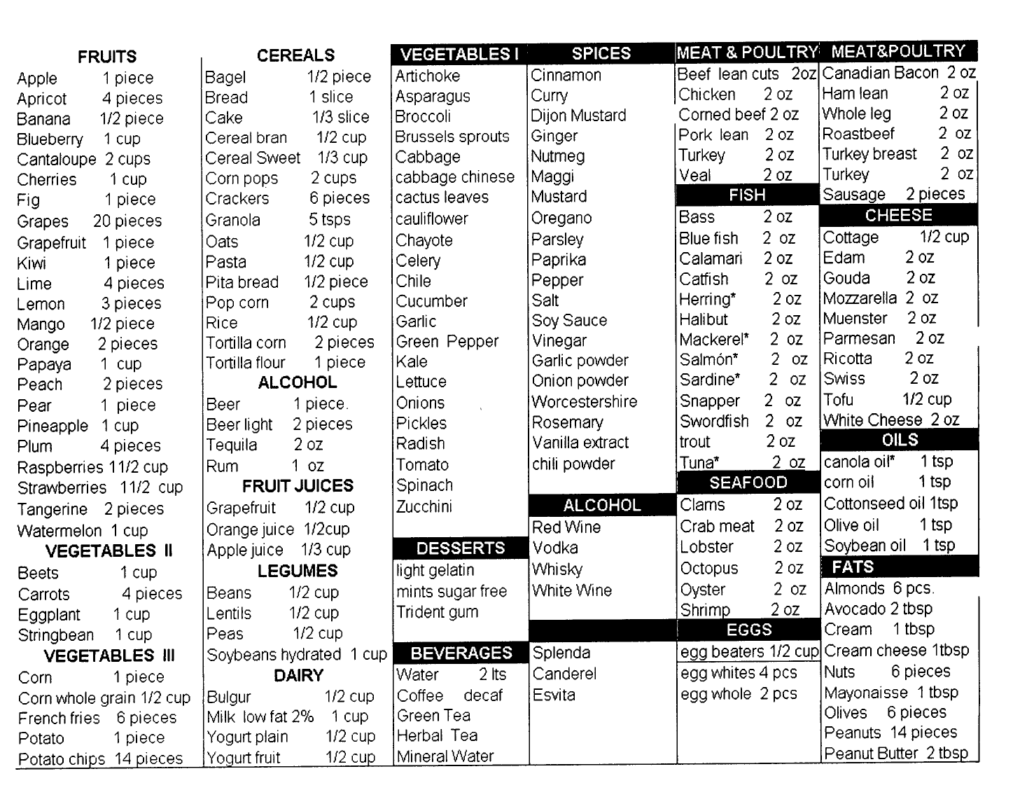

Referring to FIG. 1, the diet planner comprises a card, showing a plurality of food item lists. Such food item lists are divided into categories such as Fruits, Vegetables I, Vegetables II, Vegetables III, Cereals, Alcohol, Fruit juices, Legumes, Dairy, Desserts, Beverages, Spices, Meat & poultry, Fish, Seafood, Eggs, Cheese, Oils and Fats.

Each category name presents a characteristic color. In the preferred embodiment, the characteristics colors are the following: carbohydrates are yellow, proteins are red, fats are blue, and “free” food is green. In the present invention, the combination of one yellow (a portion of carbohydrate), one blue (a portion of fats) and one red (a portion of protein) creates a food group called “asterisk” which maintains stable the sugar levels (glucose) in the blood. In addition, a characteristic color orange is for one carbohydrate portion and one-half portion of protein.

Additionally, at the right side of each food item included in the yellow, red and blue categories, the card includes the portion or size of the food item the user is allowed to eat.

The method of the present invention provides the amount of carbohydrates that the brain needs to function without sacrificing muscle mass, and allows the person who follows it to lose weight from fat, and to remain healthy.

If the person needs to lose weight, the method of the present invention suggests that the user only consumes the amount of carbohydrates that the brain needs, which are slowly absorbed in the blood. This way, the muscles will not find fuel to function and will use the stored fat.

Accordingly to the method of the invention, if the user wishes to maintain a certain weight, the user must provide carbohydrates for brain and muscles.

If the user wishes to gain weight, the method of the present invention suggests that the user increases the amount of carbohydrates in order to be stored as fat.

Therefore, the method of the present comprises the following steps:

1) calculating the ideal weight by:

a) multiplying the user's height by height (in meters);

b) multiplying result of step 1.a by the corresponding body mass index (BMI); and

c) adjusting the result of step 1.b by considering the user's bone build and gender; and

d) obtaining the ideal weight in kg

2) calculating the daily calories to maintain the user's weight, considering the user's physical activity;

3) calculating the number of daily asterisks to maintain the user's ideal weight; and

4) selecting from the diet planner the food items that correspond to the number of daily asterisks calculated in step 3.

Before describing the first step of the method of the present invention, the applicant suggests the following procedure for converting feet and inches into meters:

A. Conversion from Feet to Inches

Multiply feet * 12=inches

Add to this result the number of inches.

Example:

5 feet 6 inches=(5 * 12)+6=66 inches

B. Conversion from Inches to Centimeters

Multiply inches * 2.54=centimeters

Example:

66 inches * 2.54=167.8 centimeters

C. Conversion from Centimeters to Meters

Move the decimal point

Example: 1.678, approximately 1.68 meters.

Additionally, the method of the present invention refers to the user's bone build (BB). Therefore, the applicant herein includes a simple procedure for obtaining it:

measure the circumference of the user's wrist in cm;

use the following formula:

$$\frac{user ’ s height in cm}{circumference of user ’ s wrist in cm} = BB$$

locate the BB result in the following table in order to determine the user's bone build:

| Bone build | Male | Female |
|---|---|---|
| Narrow | >10.4 | >11 |
| Average | 9.6-10.4 | 10.1-11 |
| Wide | <9.6 | <10.1 |

As mentioned before, the user's ideal weight is calculated in three steps:

a) multiplying the user's height by height (in meters):

height * height=X

b) multiplying result of step 1.a (X) by the corresponding body mass index (BMI):

X*BMI=Y

The value for BMI is different for gender and corresponds to:

BMI female=20.9

BMI male=22.4

c) adjusting the result of step 1.b (Y) by considering the user's bone build and gender:

female with narrow bones must subtract 4 to the Y result

female with average bones do not modify the Y result

female with wide bones must add 4 to the Y result

male with narrow bones must subtract 6 to the Y result

male with average bones do not modify the Y result

male with wide bones must add 6 to the Y result

After the adjustment, if necessary, a result Z is obtained;

d) obtaining the ideal weight in kg, which corresponds to the value of Z

It is important to mention that the ideal weight estimated with this index is an approximate value, since the ideal weight varies according to the percentage of muscle and fat. Some people do a lot of exercise, and due to the fact that muscle has a weight, they may find themselves above the ideal weight and be in perfectly physical conditions, whereas other people might have the ideal weight and may have a high percentage of fat in their bodies.

The second step of the method of the present invention relates to the calculation of daily calories to maintain the user's weight, considering the user's physical activity. Therefore, the user must multiply the ideal weight (Z) by the corresponding factor:

| Physical activity | Factor |
|---|---|
| Sedentary (any exercise) | 30 |
| Moderate exercise (30 min/day) | 35 |
| Intense exercise (1-2 hr/day) | 40 |
| Training (more than 2 hr/day) | 50 |

It is important to mention that if the user is a pregnant woman, the method of the present invention requires the addition of 300 calories to the result of daily calories. Additionally, if the user is nursing, consider an addition of 500 calories.

The data obtained indicates the amount of daily calories necessary to maintain the user's ideal weight.

The third step of the method of the present invention relates to the calculation of daily asterisks to maintain the user's ideal weight, applying the following formula:

$$daily asterisks = \frac{daily calories}{300}$$

If the user is within the ideal weight, then the user should eat that number of asterisks.

If the user wants to gain weight, then the user must add three asterisks per day.

If the user is above the ideal weight and he/she wishes to lose weight, the user must subtract three asterisks to the initial number of asterisks.

The minimum of asterisks to eat during the period the user wants to lose weight is of 3.5 asterisks for women and 4 asterisks for men.

### EXAMPLE

For a women 1.68 meters high, that weights 70 kg, her bones are narrow and she does not exercise, the method of the present invention includes:

1) calculating her ideal weight:

a) multiplying 1.68 * 1.68=2.8 (X)

b) multiplying 2.8 * 20.9=58.9 (Y)

c) adjusting the result Y, considering that the woman's bone build is narrow:

58.9−4=54.98

d) obtaining the ideal weight

Z=55 KG

2) calculating the daily calories to maintain the user's weight, considering that the woman does not exercise:

daily calories=ideal weight (Z) * factor

daily calories=55 kg * 30=1,650

3) calculating the number of daily asterisks to maintain the user's weight:

$$daily asterisks = \frac{daily calories}{300} = \frac{1650}{300}$$

daily asterisks=5.5

This woman must eat 5.5 asterisks to maintain her ideal weight. Since she weighs 70 kg and must lose weight until 56 kg, 3 asterisks are subtracted:
5.5−3=2.5 asterisks.

Since the minimum number of asterisks for a woman is of 3.5 asterisks, she must eat 3.5 asterisks per day to lose weight.

The diet planner and method of the present invention allow losing between 4 and 5 kg of fat each month. If she currently weighs 70 kg and she must weigh 56 kg, she must lose 14 kg. She will have her ideal weight in about three months.

4) selecting from the diet planner the food items that correspond to the daily 3.5 asterisks.

In order to comply with all the objectives related to the diet planner and method, the user must consider the following recommendations for selecting the daily asterisks:

At least 2 yellow asterisks should correspond to fruits, since the sugars contained reach slowly the blood, therefore a fruit can be eaten alone as a snack.

Eat 3 cups of crude vegetables corresponding to green asterisks

Preferably, consume fruit, legumes and whole cereals.

Avoid refined cereals. Every time a cereal is consumed, it should be combined with protein.

Eat only 2 portions of red lean meat per weak and prefer poultry and fish

Prefer the consume of tuna, herring, mackerel, salmon and sardine.

Avoid seafood and sausage.

Consume 3 eggs per weak

At the most, consume daily 2 cups of red wine, white wine, vodka or whisky, it is suggested to select red wine.

Select cheeses low in fats, such as cottage, and white cheese.

Vary food items.

Considering the prior mentioned, an exemplary diet of 3.5 asterisks, as proposed by the diet planner and method of the present invention, is as follows:

Breakfast

1 grapefruit (1 yellow asterisk)

2 scrambled eggs (1 red asterisk)

1 tablespoon canola oil (1 blue asterisk)

Lunch

2 oz of tuna (1 red asterisk) with salad

1 tablespoon of mayonnaise (1 blue asterisk)

1 slice of whole bread (1 yellow asterisk)

Snack

1 apple (½ yellow asterisk)

Dinner

Vegetable soup

3 oz of chicken cooked with vegetables (1.5 red asteriks) and with ½ teaspoon of corn oil (½ blue asterisk)

Salad with 1 teaspoon of olive oil (1 blue asterisk)

2 pieces of peach (1 yellow asterisk)

While the invention has been specifically described in connection with certain specific embodiments thereof, it is to be understood that this is by way of illustration and not of limitation, and the scope of the appended claims should be construed as broadly as the prior art will permit.

1. A diet planner, comprising:
a card showing a plurality of food item lists and the portion permitted,
wherein the food item lists are divided into categories,
wherein each category name presents a characteristic color, and
wherein the combination of three or more categories creates a food group called “asterisk” for maintaining stable sugar levels (glucose) in the blood.

2. The diet planner according to claim 1, wherein the categories are Fruits, Vegetables I, Vegetables II, Vegetables III, Cereals, Alcohol, Fruit juices, Legumes, Dairy, Desserts, Beverages, Spices, Meat & poultry, Fish, Seafood, Eggs, Cheese, Oils and Fats.

3. The diet planner according to claim 1, wherein the characteristic colors are: yellow for carbohydrates, red for proteins, blue for fats, and green for “free” food.

4. The diet planner according to claim 1, wherein an “asterisk” is formed by the combination of one portion of the food item from the carbohydrate category, one portion of the food item from the fats category and one portion of the food item from the protein category.

5. A method for planning a diet comprising the steps of:
1) calculating the ideal weight by:
a) multiplying the user's height by height (in meters);
b) multiplying result of step 1.a by the corresponding body mass index (BMI); and
c) adjusting the result of step 1.b by considering the user's bone build and gender; and
d) obtaining the ideal weight in kg
2) calculating the daily calories to maintain the user's weight, considering the user's physical activity;
3) calculating the number of daily asterisks to maintain the user's ideal weight; and
4) selecting from the diet planner the food items that correspond to the number of daily asterisks calculated in step 3.

6. The method according to claim 5, wherein the body mass index of a female is 20.9 and 22.4 for a male.

7. The method according to claim 5, wherein the calculation of daily calories to maintain a user's weight, considers his physical activity by using a factor.

8. The method according to claim 7, wherein the factor for sedentary life is 30; the factor for moderate exercise is 35, the factor for intense exercise is 40 and the factor for training is 50.
